(19) United States
(12) Patent Application Publication
(10) Pub. No.: US 2004/0076884 A1
(43) Pub. Date: Apr. 22, 2004

(54) Modified lithium cobalt oxide for lithium ion battery as cathode, preparation thereof, and lithium ion battery

(75) Inventors: Dzu-Chi Lee, Hsinchu (TW); Jiunn-Ren Lin, Hsinchu (TW); Jer-Yuan Shiu, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/287,547

(22) Filed: Nov. 5, 2002

(30) Foreign Application Priority Data
Oct. 18, 2002 (TW) 91124135

(51) Int. Cl. H01M 4/52; C01G 51/04

(52) U.S. Cl. 429/231.3; 423/594.6

(57) ABSTRACT

A modified lithium cobalt oxide is useful as a cathode of a lithium ion battery for increasing a charge voltage to 4.4 V. The modified lithium cobalt oxide includes a lithium cobalt oxide particle and an oxide of ZrO₂.TiO₂.B₂O₃. Al₂O₃ or Ga₂O₃ deposited on a surface of the particle. The modified lithium cobalt oxide is prepared by impregnating the lithium cobalt oxide particle in an aqueous solution containing ions of Zr, Ti, B, Al or Ga, and calcining the impregnated particle.

### FIELD OF THE INVENTION

The present invention is related to a lithium cobalt oxide (LiCoO₂) having a layered rock-salt type (alpha-NaFeO₂ type) structure, and in particular to a modified lithium cobalt oxide useful for making a cathode of a lithium ion battery for increasing a charge voltage thereof to 4.4 V.

### BACKGROUND OF THE INVENTION

Due to their extraordinary energy density, rechargeable lithium ion batteries are presently attracting attention as rechargeable power sources for use in portable electronic/electric devices such as portable telephones and notebook-type personal computers.

The current rechargeable lithium ion batteries mostly employ a lithium cobalt oxide (LiCoO₂) having a layered rock-salt type (alpha-NaFeO₂ type) structure as a cathode material, a carbonaceous material such as graphite as an anode material, and a solution of any of various organic substances including Li salt as an electrolyte. The lithium cobalt oxide has conventionally been synthesized by firing a mixture of cobalt oxide with lithium carbonate in the air at 700 to 900° C. For an attempt to reduce the high production cost due to high-temperature firing, it is necessary to find out a method in which the reaction is conducted at a lower temperature. However, a rechargeable lithium ion battery employing a sample synthesized, e.g., at around 400° C. as a cathode material has a discharge plateau around 3.5 V, which is lower than those of batteries employing a cathode material synthesized at 850° C. (about 3.8 to 4 V). In view of above, a new approach, hydrothermal oxidation, has been developed to prepare a lithium cobalt oxide (LiCoO₂) having a layered rock-salt type at a much lower temperature of about 160-300° C., for example U.S. Pat. No. 6,399,041 B1. However, the hydrothermal oxidation process is relatively complicated. Therefore, there is a need in the industry to develop a modified lithium cobalt oxide (LiCoO₂) having a layered rock-salt type, which can be used to made a cathode of a lithium ion battery, so that the lithium ion battery has an increased charge voltage and thus a longer use life.

### SUMMARY OF THE INVENTION

A primary object of the present invention is to provide a modified lithium cobalt oxide (LiCoO₂) having a layered rock-salt type, which can be used to made a cathode of a lithium ion battery, so that the lithium ion battery has an increased charge voltage, for example 4.4 V, and thus a longer use life.

Another object of the present invention is to provide a process for preparing a modified LiCoO₂.

A further object of the present invention is to provide a lithium ion battery having an increased charge voltage, for example 4.4 V.

In order to accomplish the aforesaid objects, a modified lithium cobalt oxide made according to the present invention comprises a lithium cobalt oxide particle and MOx deposited on a surface of the particle, wherein M is Zr, Ti, B, Al or Ga; and x=2, when M is Zr or Ti, or x=3/2, when M is B, Al or Ga.

The present invention also provides a lithium ion battery comprising a cathode, and said cathode comprises the modified LiCoO₂ of the present invention.

The present invention further provides a process for preparing a modified LiCoO₂ comprising the following steps: impregnating a particle of LiCoO₂ in an aqueous solution containing ions of Zr, Ti, B, Al or Ga; and calcining the resulting impregnated LiCoO₂ particle.

Preferably, the modified LiCoO₂ comprises 0.5-15% of MOx, based on the weight of the modified LiCoO₂. The modified LiCoO₂ will not be substantially changed, if the amount of MOx is less than 0.5 wt %. On the other hand, the performance of the lithium ion battery may be adversely affected, if the modified modified LiCoO₂ as a cathode contains more 15 wt % of MOx.

Preferably, MOx is ZrO₂ or B₂O₃.

In the process of the present invention, preferably the LiCoO₂ particle is impregnated in an aqueous solution of ZrO(NO₃)₂ or an aqueous solution of boric acid.

Preferably, the process of the present invention further comprises drying the resulting impregnated particle by heating prior to said calcining, and said calcining is carried out at a temperature of 400-800° C. for 1-5 hours, and more preferably at 600° C. for 3 hours.

### BRIEF DESCRIPTION OF THE DRAWINGS

FIG. 1 is a picture of LiCoO₂ particles taken by scanning electron microscope (SEM).

FIG. 2 is an energy dispersive spectroscopy (EDS) of LiCoO₂ particles.

FIG. 3 is a picture of the modified LiCoO₂ particles of the present invention taken by scanning electron microscope (SEM).

FIG. 4 is an energy dispersive spectroscopy (EDS) of the modified LiCoO₂ particles of the present invention.

FIG. 5 is a plot of the discharge specific capacity versus the number of charge-discharge cycle, wherein a) represents a lithium ion battery using a modified LiCoO₂—B₂O₃ as a cathode; b) represents a lithium ion battery using a modified LiCoO₂—ZrO₂ as a cathode; and c) represents a lithium ion battery using a commercially available LiCoO₂ a cathode.

### DETAILED DESCRIPTION OF THE PREFERRED EMBODIMENTS

The present invention chemically modifies LiCoO₂ to form LiCoO₂—MOx, wherein M and x are defined as above. The preparation of LiCoO₂ was well known in the art, and a typical process thereof includes mixing particles of Li₂CO₃ and Co₃O₄ and calcining the resulting mixture at 600˜900° C. for 5˜25 hours, preferably at 800° C. for 10 hours, to form LiCoO₂ compound. The present invention further modifies LiCoO₂ by impregnating LiCoO₂ in an aqueous solution of a water soluble precursor for forming MOx such as Zirconium nitrate and boric acid; and calcining the impregnated LiCoO₂ at 400˜800° C. for 1˜5 hours, so that M the metal ion of the water soluble precursor are oxidized to form an metal oxide of MOx deposited on a surface of LiCoO₂, i.e. LiCoO₂—MOx. The water soluble precursor is used in an amount so that the obtained LiCoO₂—MOx contains 0.5-15% of MOx, based on the weight of the modified LiCoO₂—MOx.

### EXAMPLE 1

### LiCoO₂—ZrO₂

In 20 ml aqueous solution containing 0.1 g ZrO(NO₃)₂.xH₂O (molecular weight 231.23, sold by ALDRICH Inc., US, under a code of 34646-2), 1.9 g of LiCoO₂ particles having a diameter distribution of 90% smaller than 17 μm was impregnated. The mixture was dried at 110° C., and then the dried mixture was calcined at 600° C. for 3 hours. The calcined product was grinded to be used a material for making a cathode of a lithium ion battery.

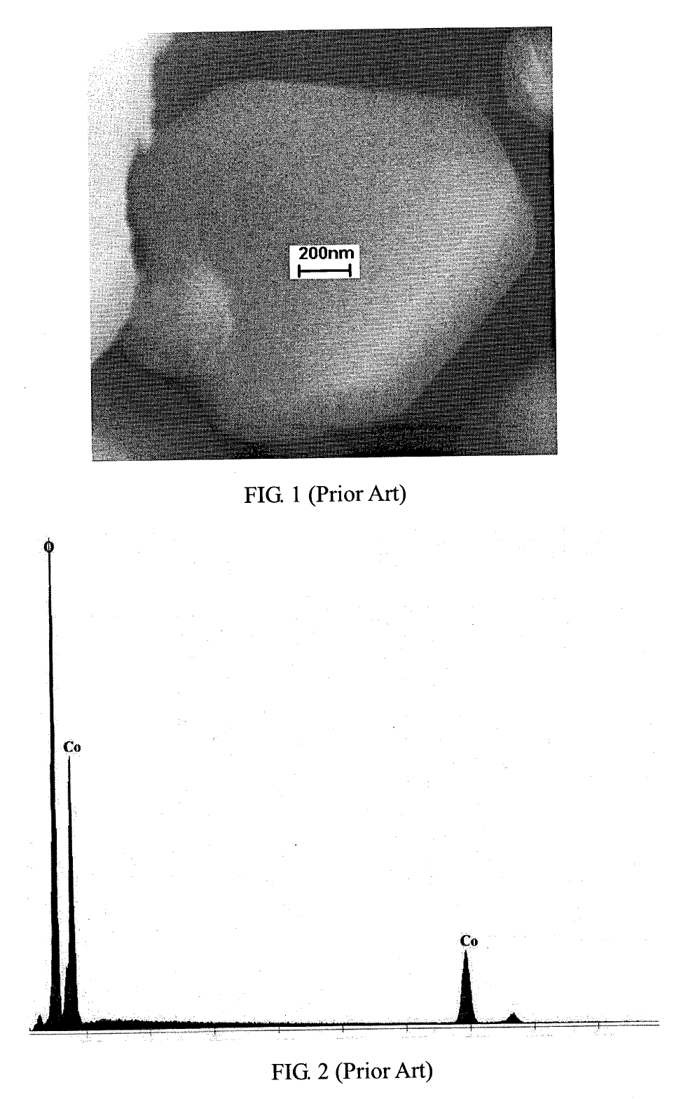

FIG. 1 shows a SEM picture of LiCoO₂ particles before modification. It can be seen from FIG. 1 that the LiCoO₂ particles before modification has substantially smooth surfaces. Moreover, an EDS spectrum of the LiCoO₂ particles before modification exhibit only peaks of oxygen and Co, as shown in FIG. 2.

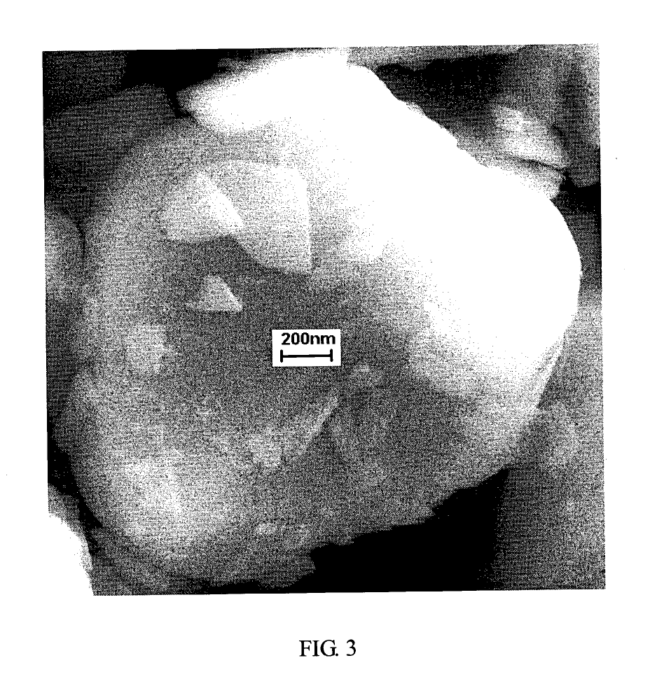

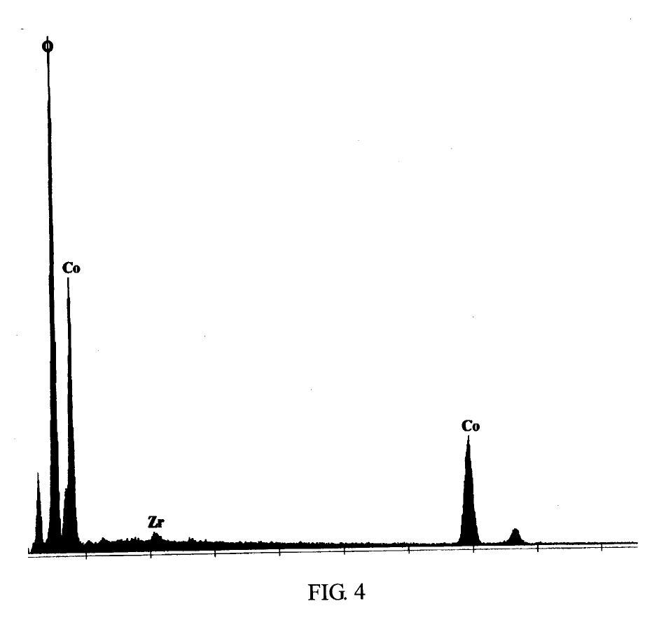

FIG. 3 shows a SEM picture of LiCoO₂ particles after modification. It can be seen from FIG. 3 that the surfaces of the LiCoO₂ particles after modification were deposited with a substance. Moreover, an EDS spectrum of the LiCoO₂ particles after modification exhibit a peak of Zr in addition to the peaks of oxygen and Co, as shown in FIG. 4.

### EXAMPLE 2

### LiCoO₂—B₂O₃

The procedures in Example 1 were repeated except that 0.1 g of boric acid powder (H₃BO₃, molecular weight 61.83, sold by ALDRICH, Inc., US, under a code of 23646-2) was used to replace the ZrO(NO₃)₂.xH₂O.

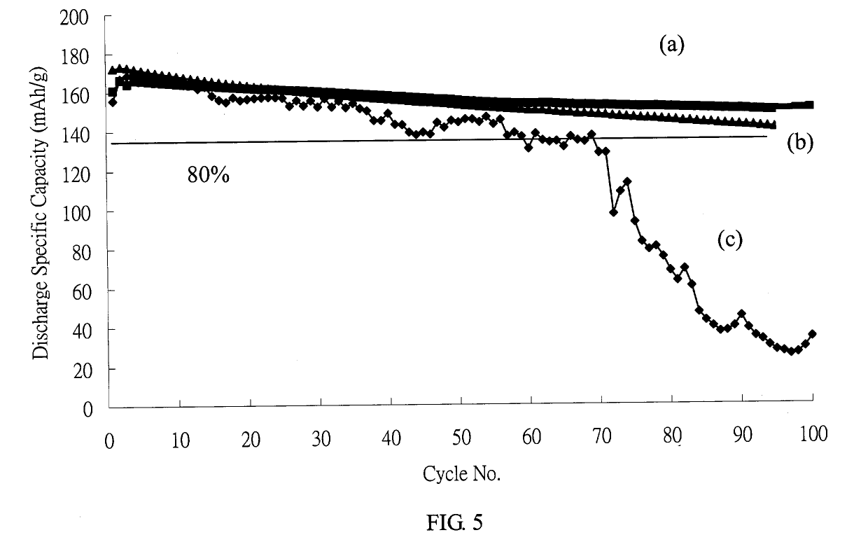

Three 2032-type button lithium ion battery were fabricated by using the samples obtained in Examples 1 and 2, and a commercially available LiCoO₂ (Nippon Chemical Industrial Co., Japan, Code: CELLSEED C) as a cathode, lithium metal as an anode, and a 1 M solution of LiPF₆ in a mixed solvent consisting of ethylene carbonate and dimethyl carbonate as an electrolyte solution. These batteries were examined for charge/discharge characteristics at 0.2C charge/discharge rate (current density: 28 mA/g). The lithium ion battery having a cathode made of the commercially available LiCoO₂ had a 20% longer battery life, when it was charged/discharged between 3-4.4 V, compared to that was charged/discharged between 3-4.2 V. However, the discharge specific capacity of the lithium ion battery after about 70 cycles of charge/discharge dropped to a value less than 80% of the original discharge specific capacity, as shown in FIG. 5, curve (c). Under the same test conditions (charged/discharged between 3-4.4 V), the performance of the lithium ion batteries having a cathode made of the modified LiCoO₂—MOx of the present invention are shown in FIG. 5, curves (a) and (b). As shown by the curve (a), where M is B, the discharge specific capacity after 100 cycles of charge/discharge maintains a level higher than 90% of the original value, and it maintains a level of about 81% of the original discharge specific capacity, when M is Zr, as shown by the curve (b).

1. A modified lithium cobalt oxide comprising a lithium cobalt oxide particle and MOx deposited on a surface of the particle, wherein M is Zr, Ti, B, Al or Ga; and x=2, when M is Zr or Ti, or x=3/2, when M is B, Al or Ga.

2. The modified lithium cobalt oxide according to claim 1, which comprises 0.5-15% of MOx, based on the weight of the modified lithium cobalt oxide.

3. The modified lithium cobalt oxide according to claim 1, wherein said MOx is ZrO₂ or B₂O₃.

4. A lithium ion battery comprising a cathode, wherein said cathode comprises a modified lithium cobalt oxide comprising a lithium cobalt oxide particle and MOx deposited on a surface of the particle, wherein M is Zr, Ti, B, Al or Ga; and x=2, when m is Ar or Ti, or x=3/2, when m is B, Al or Ga.

5. The lithium ion battery according to claim 4, wherein said modified lithium cobalt oxide comprises 0.5-15% of MOx, based on the weight of the modified lithium cobalt oxide.

6. The lithium ion battery according to claim 4, wherein said MOx is ZrO₂ or B₂O₃.

7. A process for preparing a modified lithium cobalt oxide, said modified lithium cobalt oxide comprising a lithium cobalt oxide particle and MOx deposited on a surface of the particle, wherein M is Zr, Ti, B, Al or Ga; and x=2, when M is Zr or Ti, or x=3/2, when M is B, Al or Ga, said process comprising the following steps: impregnating a particle of LiCoO₂ in an aqueous solution containing ions of Zr, Ti, B, Al or Ga; and calcining the resulting impregnated LiCoO₂ particle.

8. The process according to claim 7, wherein said LiCoO₂ particle is impregnated in an aqueous solution of ZrO(NO₃)₂ or an aqueous solution of boric acid.

9. The process according to claim 7 further comprising drying the resulting impregnated particle by heating prior to said calcining, and said calcining is carried out at a temperature of 400-800° C. for 1-5 hours.

10. The process according to claim 9, wherein said calcining is carried out at 600° C. for 3 hours.

11. The process according to claim 7, wherein said modified lithium cobalt oxide comprises 0.5-15% of MOx, based on the weight of the modified lithium cobalt oxide.

12. The process according to claim 7, wherein said MOx is ZrO₂ or B₂O₃.
